(19) United States
(12) Patent Application Publication
(10) Pub. No.: US 2004/0103859 A1
(43) Pub. Date: Jun. 3, 2004

(54) Diesel emission and combustion control system

(76) Inventor: Michael Shetley, Okeechobee, FL (US)

Correspondence Address: MCHALE & SLAVIN, P.A., 2855 PGA BLVD, PALM BEACH GARDENS, FL, 33410, US

(21) Appl. No.: 10/307,090

(22) Filed: Nov. 29, 2002

(51) Int. Cl. F02B 47/00

(52) U.S. Cl. 123/25 J

(57) ABSTRACT

The present invention relates to a system and method for improving the combustion of diesel fuels within the combustion chamber of the engine. The invention is capable of reducing particulate matter emissions, nitrogen oxide emissions, and hydrocarbon emissions via electronically controlled injection of liquid solutions/emulsions containing water and a booster fuel into the intake air of a diesel engine. The booster fuel contained in the liquid solution/emulsion allows control of fuel ignition and enhances combustion causing a smooth thorough burning of the compressed mixture. Cooled air entering the combustion chamber allows the air exiting the combustion chamber to have an increased heat capacity. Increased heat capacity reduces flame temperatures within the cylinder. The combination results in a longer burn with a lower temperature and lower peak pressure in the combustion chamber. As a result PM, HC and NOx emissions are improved for a specified diesel engine power level.

### FIELD OF THE INVENTION

This invention relates to a device and method for improving the combustion of diesel fuels to reduce nitrogen oxide emissions and hydrocarbon emissions via electronically controlled injection of liquid solutions/emulsions containing water and a booster fuel into the intake air of a diesel engine.

### BACKGROUND OF THE INVENTION

Diesel engines have a number of important advantages over gasoline engines. They provide reliability, long life, and good fuel economy, and are expected to remain the dominant heavy-duty transport power plants for several years. However, diesel engines present some emission problems that are more severe than their gasoline counterparts. Diesel engine exhaust is a principle deterrent to the more wide spread use of these power plants. Diesel emission problems generally relate to Nitrogen Oxides (NOx), particulate matter (PM), hydrocarbons (HC) and carbon monoxide (CO) discharged into the air within the exhaust gasses. It is desired to minimize these emissions due to their negative effects on the environment.

This invention relates to a method of improving the combustion of diesel fuel within the combustion chamber of the engine to improve exhaust emissions and reduce fuel consumption. More particularly, the invention reduces HC, and NOx emissions being expelled from the exhaust by causing a more uniform burning of the diesel fuel.

It is known that the formation of emissions such as NOx can be reduced by adding water to the combustion process of an internal combustion engine. This phenomenon is based on the cooling effect of the added water, and there is a considerable amount of prior art in the field. Much of the prior art has concentrated on introducing larger quantities of water to the engine in efforts to further reduce NOx emissions. While the prior art has been successful in reducing NOx and HC emissions, the prior art has not achieved the level of reductions achieved by the instant invention.

In practice, the injection of water into an engine has typically been accomplished in two alternative methods. The first method involves introducing the water through an inlet air passage, where the vacuum of the engine draws the air water mixture into the cylinder, e.g. humidification. The second method involves injecting the water directly into the cylinder of the engine, e.g. direct injection. Each of these methods, as practiced with the prior art, have their own disadvantages with respect to emissions.

Various apparatus have been proposed for humidifying air entering the engine. It has been proposed to inject water and/or steam into the flow of inlet air at various locations along the intake air path. With humidification only water that remains in a gaseous state will be drawn into the cylinder with the incoming air. The maximum quantity of water that can be introduced into the combustion chamber using this method is limited to saturation of the incoming air. The injection nozzles utilized by the prior art created small droplets of water that could not be fully vaporized by the intake air flow, resulting in unsatisfactory saturation of the intake air. Efforts to increase vaporization of the droplets have relied on steam or low pressure to increase the water content of the air/fuel mixture for combustion. However, the power output of the engine suffers when the pressure of the incoming air is reduced or the air temperature is increased to allow feeding a greater quantity of water.

Alternatively, a large quantity of water may be injected into the combustion chamber using direct injection. When water is injected directly into the combustion chamber of an engine, the injection usually takes place during the compression stroke either before and/or during the combustion process. The heat of the combustion chamber is used to vaporize the small droplets of water. However, engine power suffers when large quantities of water are introduced directly to the combustion chamber. The water over-cools the compressed air/fuel mixture and reduces the pressure within the cylinder. The reduced pressure delays the start of combustion of the air/fuel mixture resulting in increased HC and PM emissions being discharged from the engine.

It is also known that the addition of a secondary fuel can aid in the combustion of the primary fuel. There is a considerable amount of prior art in this field, however, much of the effort has concentrated on the addition of gaseous fuels such as natural gas, methane gas, liquid petroleum gas or others. Controlling the amount of the two fuels entering the combustion chamber has proven difficult with this method. The non-linearity of pump characteristics and the widely varying loads of such vehicles as transport vehicles, agricultural vehicles and heavy motorized equipment have required extremely precise mixing and injection techniques to produce an acceptable torque output from the engine.

Liquid additives are also commonly added to tanks of diesel fuel to prevent corrosion, boost the cetane rating or to condition the fuel to prevent freezing. This method requires the operator to guess how much additive the fuel will need before operation. After the additive is poured into the fuel changing the mixture for different driving conditions is extremely difficult.

Accordingly, a cost effective, reliable and versatile system for improving combustion and reducing emissions from diesel fuels that can be easily adapted to existing diesel engines without extensive modification would satisfy a long felt need in the art.

### DESCRIPTION OF THE PRIOR ART

U.S. Pat. No. 5,148,776 teaches a coordinated water injection system for an internal combustion engine in which a computer calculates the minimum fuel requirements to meet the power demand and the water requirements to achieve smooth operation without engine knock or pre-ignition.

U.S. Pat. No. 6,415,745 discloses a method of reducing NOx emissions of a four-stroke turbo-charged piston engine by injecting water or steam into the combustion chamber of the engine. The injection of water is initiated after the intake valve has moved through 50% of its total range of opening.

Air humidification devices in the prior art have suffered from an inability to fully saturate the intake air without lowering pressure and/or raising temperature of the incoming air. As a result these devices have failed to adequately reduce emissions without detrimental effects to power output of the engine. Direct injection devices have overcooled the combustion chamber and caused difficulty with igniting the compressed fuel charge. Due to the difficulties combusting these mixtures, the amount of particulate matter released from the engine is significantly increased.

U.S. Pat. No. 5,809,774 discloses a process for delivering a fuel and a reagent to an engine and a selective catalytic reduction device for controlling emissions from an engine. Proper operation of this device requires fuel, water and a NOx reducing agent, e.g. urea, to be mixed into an emulsion. Before the emulsion enters the engine, the fuel is separated from the water/urea mixture. The fuel is fed to the engine and the water/NOx reducing agent is fed to a catalyst reduction device. The hot exhaust gases are then allowed to flow through the catalyst reduction device where the water/NOx reducing agent, in combination with the catalyst, reduces the amount of NOx contained in the exhaust gas before discharging the exhaust to the air.

Water combined with ammonia or urea tends to lower the cetane rating of the fuel compounding the difficulty with ignition. Lower cetane fuels take longer to ignite than high cetane fuels and when they do ignite they generate an extreme pressure rise within the combustion chamber. This pressure rise indicates explosive combustion or detonation; the cause of loud knocking often heard from engines utilizing these devices.

U.S. Pat. No. 4,412,512 teaches a fuel supply system in which oil and water are mixed to form an emulsion which is delivered through a conduit having an agitation means to a nozzle or other atomizing means at which combustion occurs.

U.S. Pat. No. 6,397,826 teaches a fuel emulsion injection system. This system combines fuel, water and a surfactant into an emulsion and directly injects it into the engine. Unused fuel is forced through a cooler before returning to the tank.

Fuel and water emulsions create a variety of problems in use. Emulsions quickly separate without agitation or the addition of a surfactant. Emulsions utilizing a surfactant tend to separate at higher temperatures as the surfactant loses its effectiveness. Emulsions also tend to gel or freeze at higher temperatures than pure fuel.

U.S. Pat. No. 6,386,149 teaches a method of operating an engine with a mixture of gaseous fuel and emulsified pilot fuel to reduce nitrogen oxide emissions.

U.S. Pat. No. 6,439,192 discloses a gaseous and liquid fuel injection valve body that houses two separate concentric valve assemblies. The gaseous fuel valve assembly controls the injection of gaseous fuel into the combustion chamber, and the liquid fuel valve controls the injection of liquid fuel into the combustion chamber. One of the valve nozzles is rotatable to change the position of the liquid fuel holes in respect to the gaseous fuel holes to tune the injection of the two fuels for the best combustion.

Adjustment of this type of device is difficult. Variations in the two fuels combined with varying load conditions of most engines require constant adjustment to cause an efficient burn of the mixtures. These devices are more suited for constant load engines.

None of the prior art patents disclose an injection device capable of producing a superfine atomization for saturating the air entering a diesel engine. Nor do they suggest injection of a solution of water and/or alcohol combined with a booster fuel to control combustion and cause a longer, thorough burn of the primary fuel throughout the combustion cycle to control emissions.

### SUMMARY OF THE INVENTION

It is known that while NOx emissions can be reduced by injecting water into a diesel engine, it can also quench combustion causing some emissions to increase. It is also known that secondary fuels can be added to diesel fuels to aid in their combustion. The present invention provides a system and method for injecting solutions/emulsions combining water/alcohol and a booster fuel to control the combustion of diesel fuels and reduce emission output.

In operation, the liquid solution/emulsion flows from a tank through a conduit and enters an injector mounted onto the intake air duct of an engine. An electrical control module causes the injector to force the liquid solution/emulsion through a nozzle at high pressure to create a superfine atomized spray which is directed into the air flowing through the intake air duct. The intake air is cooled and saturated with the liquid solution prior to being drawn into the combustion chamber. Fuel is injected into the combustion chamber ahead of top dead center to allow the air/fuel/liquid solution mixture time to be heated during compression in order for proper ignition to begin. This time allowance is called the ignition delay and is crucial to the correct operation of the engine. The booster fuel contained in the liquid solution/emulsion allows control of fuel ignition and enhances combustion causing a smooth thorough burning of the compressed mixture. Cooled air entering the combustion chamber allows the air exiting the combustion chamber to have an increased heat capacity. Increased heat capacity reduces flame temperatures within the cylinder. The combination results in a longer burn with a lower temperature and lower peak pressure in the combustion chamber. As a result PM, HC and NOx emissions are improved for a specified diesel engine power level.

Accordingly, it is an objective of the present invention to provide a method for reducing PM emissions, HC emissions and NOx emissions expelled from the exhaust of a diesel engine by injecting a superfine atomized liquid solution/emulsion into the flow of air entering the engine.

It is a further objective of the present invention to provide a method for reducing PM emissions, HC emissions and NOx emissions expelled from the exhaust of a diesel engine by injecting a superfine atomized liquid solution/emulsion, containing water and/or alcohol and a booster fuel, into the flow of air entering the engine.

It is another objective of the present invention to provide a device capable of lowering combustion temperatures and regulating the burn time of the fuel charge within the combustion chamber of a diesel engine by injecting a superfine atomized liquid solution/emulsion into the flow of air entering the engine.

It is a further objective of the present invention to provide a device for reducing PM emissions, HC emissions, and NOx emissions expelled from the exhaust of a diesel engine that can be easily installed on existing equipment.

It is yet another objective of the present invention to provide a liquid injection kit capable of delivering a superfine atomized mist into the intake air flow of an engine that can be easily installed on existing diesel engines to reduce PM emissions, HC emissions, and NOx emissions expelled from the engine.

It is still yet another objective of the present invention to provide a liquid injection kit which is inexpensive to manufacture and which is simple and reliable in operation.

It is still yet another objective of the present invention to provide a liquid injection kit which is simple to install and which is ideally suited for original equipment and after market installations on diesel engines.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a partial section view of a diesel engine illustrating one embodiment of the present invention;

FIG. 2 is a section view along section line 1-1 of FIG. 1 showing the liquid solution injector and the universal injector socket attached to the intake duct of a diesel engine.

FIG. 3 is a comparative chart illustrating the improvement in hydrocarbon emissions for a 1996 Mack truck having a six cylinder diesel engine utilizing the present invention.

FIG. 4 is a comparative chart illustrating the improvement in NOx emissions for a 1996 Mack truck having a six cylinder diesel engine utilizing the present invention.

### DETAILED DESCRIPTION OF THE INVENTION

Although the invention is described in terms of a preferred specific embodiment, it will be readily apparent to those skilled in this art that various modifications, rearrangements and substitutions can be made without departing from the spirit of the invention. The scope of the invention is defined by the claims appended hereto.

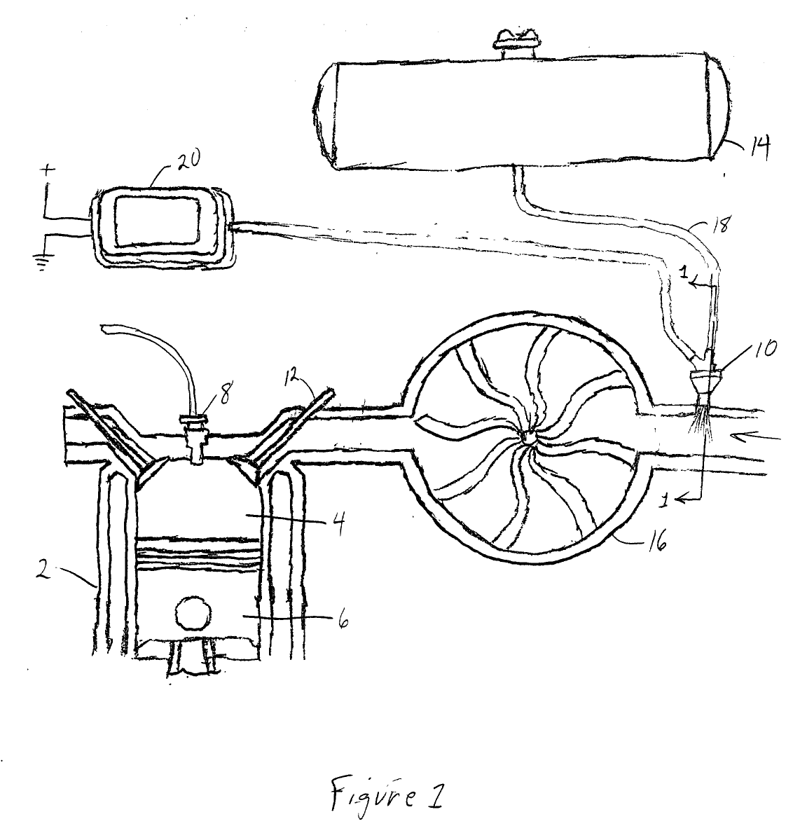

In order to alleviate the problems associated with NOx, PM, and HC emissions from diesel engines, and due to the unsuitability of the prior art to be installed on pre-existing equipment without extensive modification to the equipment, the present invention utilizes an electrically controlled liquid solution injection system 100 as set forth in FIG. 1.

In accordance with FIG. 1, the diesel engine 2 embodying the present invention has at least one and typically a plurality of combustion chambers 4 with a piston 6 reciprocatively disposed in each of the combustion chambers 4 and operatively connected to a crankshaft, not shown. An injector 8 is located within each combustion chamber 4 for injecting diesel fuel into the combustion chamber 4. A tank 14 for holding a supply of the liquid can be mounted at any convenient location on the vehicle. In the preferred embodiment the tank is mounted within the engine compartment at a height that allows the liquid to gravity feed through a supply line 18 to the liquid injector 10. In the preferred embodiment the liquid injector 10 is mounted prior to the turbo-charger 16 of the engine 2. The liquid injector 10 is mounted within a universal socket 11. The universal socket 11 is constructed and arranged to accommodate a variety of injector bodies. The size and shape of the injector body may vary based on the volume of liquid injected per spray cycle. The preferred embodiment utilizes a high performance injector generally used for racing applications. The liquid injector 10 in the preferred embodiment is capable of fast actuation and delivering about 0.10 cubic inches of fluid per spray cycle. The nozzle of liquid injector 10 is constructed and arranged to produce a superfine atomized spray of liquid when actuated. An electric control module 20 is constructed and arranged to communicate with the liquid injector 10. The electric control module 20 adjustably and timingly cycles the liquid injector 10. In the preferred embodiment the electric module 20 causes the liquid injector 10 to cycle about once every second. One spray cycle of liquid injector 10 can be completed in about 0.05 milliseconds. During actuation, the volume of liquid contained in liquid injector 10 is forced at high pressure through the nozzle causing a superfine atomized spray to be directed into the intake air stream. The superfine spray is easily vaporized by the passing intake air and easily combusted within the combustion chamber 4. The liquid may be comprised of various combinations of water and/or alcohol and a booster fuel and may be a solution or an emulsion. The combination of the solution/emulsion can be varied to control the ignition delay and duration of the combustion cycle based on the desired results. For example, where the injection of large amounts of water are desired, the amount of booster fuel in the solution can be increased to reduce the quenching effect of the water. In the preferred embodiment the liquid is a solution containing about 48 parts water and about 1 part booster fuel. A variety of booster fuels are available and well known in the art to alter the combustion characteristics of diesel fuel. A suitable emulsifier or emulsion stabilizer known to the skilled artisan, for example alkanolamides and phenolic surfactants such as ethoxylated alkyphenols, as well as other phenolic and other art known surfactants, may be added to the emulsion to aid in maintaining a homogenous mixture. Those skilled in the art can determine the proper combination of booster fuel and water/alcohol needed for a particular application by routine experimentation.

It is also anticipated that the liquid injector can be mounted in other places along the intake air flow such as: after a turbo-charger, before or after an inter-cooler, in an air inlet chamber and/or inlet passage, before or after a supercharger, or within the cylinder.

In another alternative embodiment the tank 14 may be mounted in a remote location or a location where gravity feed of the liquid solution is not possible. In those situations a pump may be utilized to force the liquid solution through the supply line 18 to the liquid injector 10.

In a further embodiment of the present invention the engine operator may have a control mechanism to adjust the timing of electric module 20. The adjustment provided by the operator could vary the amount of liquid sprayed into the engine by the liquid injector 10.

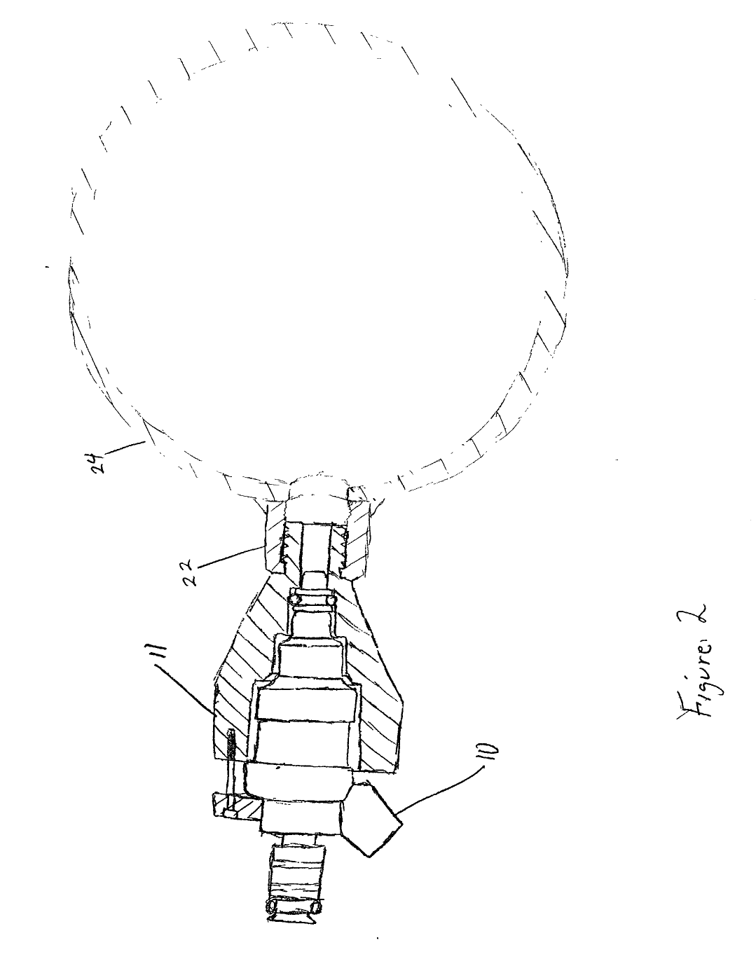

FIG. 2 shows the liquid injector 10 installed within the universal injector socket 11. The universal injector socket 11 is constructed and arranged for suitable attachment to nipple 22. Thread engagement is the preferred method of attachment but other attachment means well known in the art may be used. The universal injector socket 11 is constructed of aluminum in the preferred embodiment but may be constructed of other suitable materials which may include but should not be limited to rubber, plastic, metal, phenolic, fiber-glass or combinations thereof. The universal injector socket 11 has a plurality of internal bores centrally located for locating, protecting and attaching a suitable liquid injector 10. The nipple 22 in the preferred embodiment is constructed of aluminum, but may be constructed of other suitable materials which may include but should not be limited to rubber, plastic, metal, phenolic, fiber-glass or combinations thereof. The nipple 22 should be suitably attached to the intake air duct 24 by any suitable method which is well known in the art which may include but should not be limited to welding, epoxying or glueing. The nipple 22 being generally tubular in shape and having an internal bore, the bore extending through the generally tubular air intake duct 24 so that injector 10 is in fluid connection with intake air entering the engine.

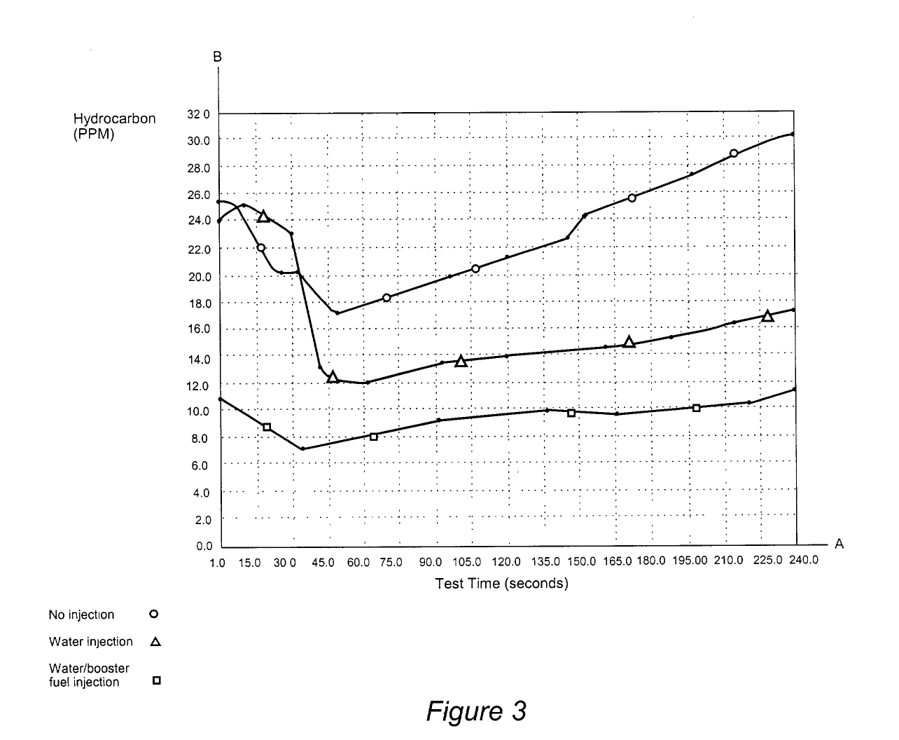

In FIG. 3, the measurement of test time in seconds is represented by axis A and the hydrocarbon (HC) exhaust output in parts per million is represented by axis B. The figure shows the hydrocarbon output of a 1996 Mack truck having a six cylinder diesel engine started with an ambient temperature of approximately 85° F. The engine was started and throttled to maintain approximately 1700 RPMs throughout the test. The relative output of hydrocarbons for the Mack truck running on diesel without injection of any water or booster fuel is denoted by curve 1. Curve 1 is marked on the graph with a hollow circle. The relative output of hydrocarbons for the Mack truck running on diesel with water injection only is denoted by curve 2. Curve 2 is marked on the graph with a hollow triangle. The relative output of hydrocarbons for the Mack truck running on diesel with the injection of a combination of water/booster or booster fuel is denoted by curve 3. Curve 3 is marked on the graph by a hollow square.

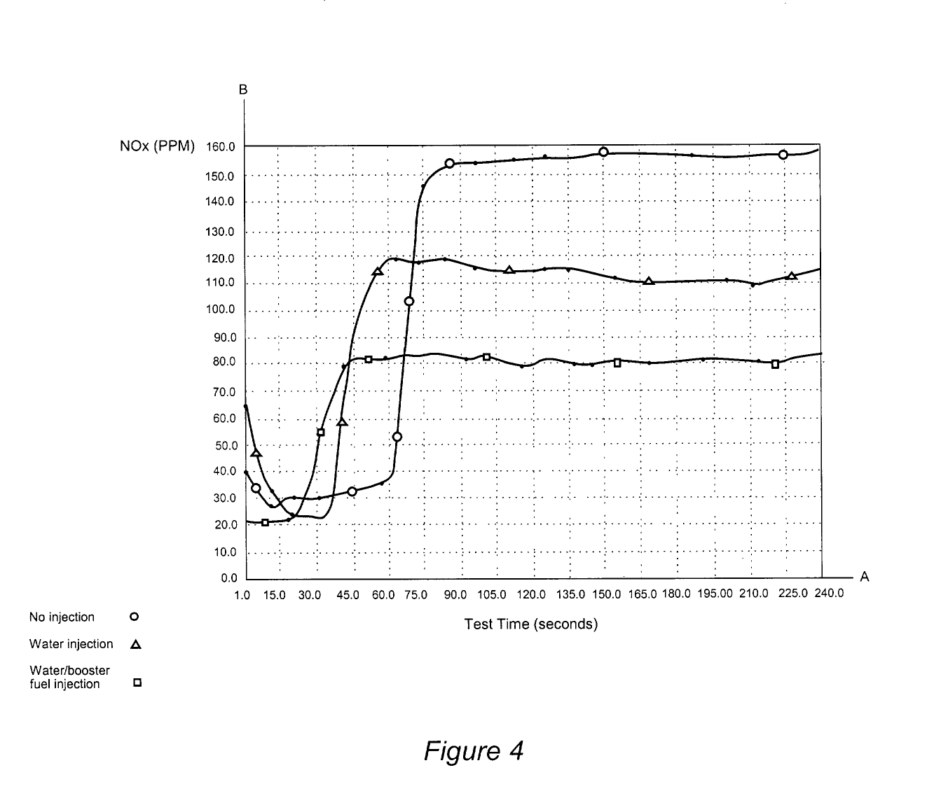

In FIG. 4, the measurement of test time in seconds is represented by axis A and the NOx exhaust output in parts per million is represented by axis B. The figure shows the NOx output of a 1996 Mack truck having a six cylinder diesel engine started with an ambient temperature of approximately 85° F. The engine was started and throttled to maintain approximately 1700 RPMs throughout the test. The relative output of NOx for the Mack truck running on diesel without injection of any water or booster fuel is denoted by curve 1. Curve 1 is marked on the graph with a hollow circle. The relative output of NOx for the Mack truck running on diesel with water injection only is denoted by curve 2. Curve 2 is marked on the graph with a hollow triangle. The relative output of NOx for the Mack truck running on diesel with the injection of a combination of water/booster or booster fuel is denoted by curve 3. Curve 3 is marked on the graph by a hollow square.

As can be plainly seen by examination of graphs 3 and 4 the present invention provides a method of improving the combustion of diesel fuel within the combustion chamber of the engine to improve exhaust emissions and reduce fuel consumption. More particularly, the present invention significantly decreased HC, and NOx emissions being expelled from the exhaust by causing a more uniform burning of the diesel fuel. Without the present invention the same diesel engine, running under the same load conditions, at the same RPM, and started at the same ambient temperature, emitted significantly larger amounts of both pollutants.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A method as practiced on a diesel engine for reducing nitrogen oxide, hydrocarbon, and particulate emissions during operation of said engine, with said engine having at least one combustion chamber, comprising:
advancing air into said combustion chamber;
injecting a liquid into said air as it advances into said combustion chamber, wherein said liquid is selected from the group consisting of water, alcohol or combinations thereof and a booster fuel;
injecting a fuel into said combustion chamber; and
compressing a mixture which includes said air, said liquid and said fuel within said combustion chamber during a compression stroke of said engine, whereby heat generated by compression of said mixture causes combustion of said booster fuel and said fuel;
whereby said injected liquid reduces flame temperatures within said combustion chamber allowing control of ignition delay and combustion duration, resulting in a reduction in particulate matter emission, hydrocarbon emission, and nitrous oxide emission.

2. A method in accordance with claim 1 wherein:
said engine includes a cylinder which defines said combustion chamber, and an air intake conduit in fluid communication with said cylinder;
said liquid injection step includes a liquid supply tank, a liquid injector operatively positioned within said intake conduit, and a control module for operative control of said liquid injector so as to cause said liquid to be injected as a superfine atomized spray into said air advancing into said combustion chamber during an intake stroke of said engine.

3. A method in accordance with claim 1 wherein said injected liquid is a solution.

4. A method in accordance with claim 1 wherein said injected liquid is an emulsion.

5. A method in accordance with claim 4 wherein said emulsion further contains a surfactant for maintaining a homogenous mixture.

6. A nitrogen oxide, hydrocarbon, and particulate emission reduction kit for installation on a new or existing diesel engine comprising:
a injector attachment means, constructed and arranged for attachment to the intake conduit of said diesel engine;
a liquid supply tank constructed and arranged to contain a supply of a liquid;
a liquid injector in fluid communication with said supply tank, said liquid injector constructed and arranged for cooperative engagement with said attachment means; and
an electric control module in communication with said liquid injector, said control module constructed and arranged for operative control of said liquid injector.

7. A nitrogen oxide, hydrocarbon, and particulate emission reduction kit for installation on a new or existing diesel engine of claim 6 wherein said liquid injector further comprises a nozzle having at least one orifice.

8. A nitrogen oxide, hydrocarbon, and particulate emission reduction kit for installation on a new or existing diesel engine of claim 7 wherein said liquid injector nozzle produces a superfine atomized spray when said liquid injector is actuated.

9. A nitrogen oxide, hydrocarbon, and particulate emission reduction kit for installation on a new or existing diesel engine of claim 6 wherein said liquid injector actuates within about 0.05 milliseconds.

10. A nitrogen oxide, hydrocarbon, and particulate emission reduction kit for installation on a new or existing diesel engine of claim 6 wherein said liquid injector injects about 0.1 cubic inches of liquid solution when actuated.

11. A nitrogen oxide, hydrocarbon, and particulate emission reduction kit for installation on a new or existing diesel engine of claim 7 wherein said injector attachment means further comprises an injector socket, said injector socket having a plurality of internal bores constructed and arranged for locating and attaching said liquid injector to said intake conduit so that said liquid injector nozzle is in fluid communication with intake air flowing through said intake conduit.

12. A nitrogen oxide, hydrocarbon, and particulate emission reduction kit for installation on a new or existing diesel engine of claim 6 wherein said electric control module actuates said liquid injector in about 0.05 milliseconds.

13. A nitrogen oxide, hydrocarbon, and particulate emission reduction kit for installation on a new or existing diesel engine of claim 6 wherein said electric control module timingly actuates said liquid injector from one to twenty times per second.
